(19) United States
(12) Patent Application Publication
(10) Pub. No.: US 2006/0056663 A1
(43) Pub. Date: Mar. 16, 2006

(54) Keyless entry using biometric identification

(76) Inventor: Clark E. Mc Call, Ann Arbor, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/939,550

(22) Filed: Sep. 13, 2004

(51) Int. Cl. G06K 9/00

(52) U.S. Cl. 382/115

(57) ABSTRACT

A keyless entry system for use on a vehicle comprises at least one processor on-board the vehicle for receiving biometric data and comparing the biometric data with the stored biometric data. A biometric scanner is coupled to the processor and accessible from the exterior of the vehicle for deriving the biometric data.

### TECHNICAL FIELD

This invention relates generally to keyless entry systems, and more particularly to a keyless entry system for gaining access to a vehicle and utilizing biometric identification.

### BACKGROUND

Door-locks, trunk-locks, and the like are commonplace on vehicles such as automobiles, trucks, sport utility vehicles, etc. In some cases, access to such vehicles is based on a token (e.g. a key, keyfob, etc.) possessed by an individual presumably authorized to enter the vehicle. In other cases, access to a vehicle is based on what an individual knows (e.g. a code, password, etc.). For example, many vehicles are equipped with keyless entry systems that may include a portable fob having controls thereon that enable the user to unlock the vehicle's doors and perform other functions through encoded RF signals transmitted to a receiver located on the vehicle. Depending on the system, the user may also activate and deactivate alarms, turn lights on and off, and in some cases start the vehicle. Certain of these vehicles, luxury cars in particular, may be equipped with door-mounted keyless entry systems. Such systems typically utilize a keypad positioned proximate a vehicle's door handle, thus enabling an authorized user to key in a numeric or alphanumeric code, and if the code is correct, the door or doors are automatically unlocked allowing the user to enter the vehicle. Inputting the correct code may alto turn interior lights on, enable the ignition system, etc.

Unfortunately, systems that enable an individual to enter a vehicle based on (1) what the individual possesses (e.g. a key), or (2) what the individual knows (e.g. a code) have certain shortcomings. Tokens such as keys may be lost, borrowed, or stolen. Codes or passwords may be lost, forgotten, or otherwise compromised by sharing with other individuals, using common passwords for multiple applications, writing passwords down where they may be stolen or viewed by unauthorized individuals, and the like. In any event, the person or persons having possession of the token or knowledge of the access code may, in fact, not be an authorized individual. Thus, “what-you-have” and “what-you-know” systems may not prevent unauthorized access.

Biometrics refers to the automatic identification of a person based on who he or she is, rather than what he or she possesses or knows. That is, a biometric system is essentially a pattern recognition system which makes a personal identification by determining the authenticity of a specific physiological or behavioral characteristic possessed by the user. This method of identification is preferred over traditional methods involving passwords and PIN numbers for various reasons: (i) the person to be identified is required to be physically present at the point-of-identification; and (ii) identification based on biometric techniques obviates the need to remember a password or carry a token. While various types of biometric systems are being used for real-time identification, the most popular are based on fingerprint matching. However, other biometric parameters such as iris and retinal scan, speech, facial thermograms, hand geometry, and others may be utilized.

It would therefore be desirable to provide a vehicular keyless entry system utilizing biometric identification. It would further be desirable to provide a biometric, keyless entry system that includes a wireless access transmitter so as to permit deployment of the system without extensive vehicle integration.

### BRIEF SUMMARY

According to an aspect of the invention there is provided a keyless entry system for use on a vehicle. The system comprises an on-board processor for receiving biometric data and comparing the biometric data with stored data, and a biometric scanner coupled to the processor and accessible from the exterior of the vehicle for deriving the biometric data.

According to a further aspect of the invention there is provided a keyless entry system for unlocking a door-lock of a vehicle's door comprising an on-board processor for receiving fingerprint data and comparing said fingerprint data with stored fingerprint data. A first fingerprint scanner is coupled to the processor and accessible from the exterior of the vehicle for generating the fingerprinting data. An activator transmitter coupled to the processor transmits a wireless activation signal when the fingerprint data substantially matches the stored fingerprint data. A wireless receiver system is coupled to the door lock for unlocking the door in response to receipt of the activation signal.

### BRIEF DESCRIPTION OF THE DRAWINGS

The following drawings are illustrative of particular embodiments of the invention and therefore do not limit the scope of the invention, but are presented to assist in providing a proper understanding. The drawings are not to scale (unless so stated) and are intended for use in conjunction with the explanations in the following detailed description. The present invention will hereinafter be described in conjunction with the appended drawings, wherein like numerals denote like elements, and:

FIG. 1 is a block diagram of the major components of a keyless entry system employing biometric identification in accordance with the present invention;

FIG. 2 illustrates a vehicle having a fingerprint scanner positioned proximate a door-handle of the vehicle;

FIG. 3 is a schematic diagram of a capacitive fingerprint sensor; and

FIGS. 4, 5, and 6 illustrate an example of a fingerprint scanner suitable for use in the biometric keyless entry system shown in FIG. 1.

### DETAILED DESCRIPTION

The following detailed description of the invention is exemplary in nature and is not intended to limit the scope, applicability, or configuration of the invention in any way. Rather, the following description provides a convenient illustration for implementing exemplary embodiments of the invention. Various changes to the described embodiments maybe made in the function and arrangement of the elements described herein without departing from the scope of the invention.

As stated previously, a biometric is a measurable, physical characteristic or personal behavioral trait used to recognize the identity or verify the claimed identity of an enrolled user. Physical features typically used for biometric identification are fingerprint, voice, retinal or iris, facial or hand geometry. By determining an individual's physical features in an authentication inquiry and comparing this data with stored biometric reference data, identification for a specific user can be determined and authentication for access can be granted. Examples of such systems are shown and described in U.S. Pat. No. 6,507,662 issued Jan. 14, 2003 and entitled “METHOD AND SYSTEM FOR BIOMETRIC RECOGNITION BASED ON ELECTRIC AND/OR MAGNETIC PROPERTIES”; and U.S. Pat. No. 6,50,4470 issued Jan. 7, 2003 and entitled “ACCESS CONTROL SYSTEM INCLUDING FINGERPRINT SENSOR ENROLLMENT AND ASSOCIATED METHODS”.

Everyone is known to have unique, immutable fingerprints. A fingerprint is made of a series of ridges, splits, dots, valleys, and furrows, as well as the minutiae points. Minutiae points are local ridge characteristics that occur at either a ridge bifurcation or a ridge ending. These characteristics are then converted to a unique digital fingerprint template that can be stored in a smart card or central database for subsequent matching and authentication processes.

Thus, fingerprints represent a unique marker for each person, even identical twins. They represent unique, built-in, easily accessible identity cards that reside literally at each individual's fingertips. Unlike keys, codes, and passwords, a fingerprint cannot be lost, forgotten, stolen, or shared. While two prints may look substantially the same at a glance, a fingerprint scanner collects the unique physical characteristics of a fingerprint being scanned and compares these characteristics to one or more reference samples in a central repository (e.g. a memory). Such fingerprint scanners and related software are well known and commercially available from companies such as Saflink Corporation, Bellevue, Wash.; ISL Biometrics, Worcestershire, UK; and Aventura Technologies, Aventura, Wash.

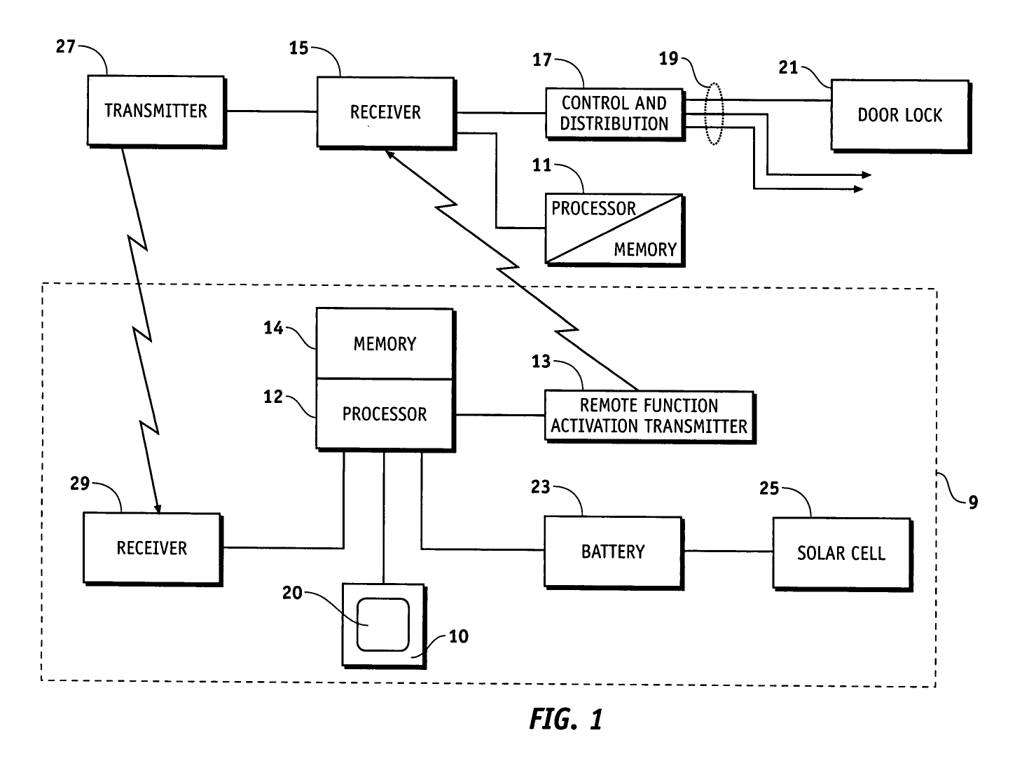

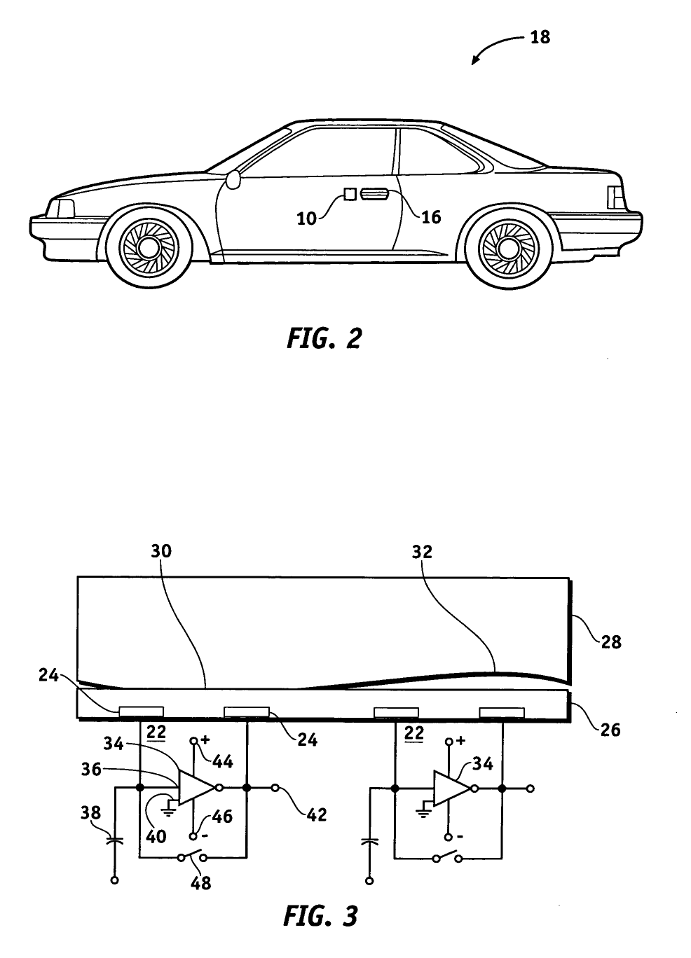

FIG. 1 is a block diagram illustrating major components of the inventive keyless entry system employing biometric identification. While the invention will be described in connection with the use of biometric parameters and scanners associated with fingerprints, it will be understood by those skilled in the art that other biometric parameters and associated equipment may be utilized.

Referring to FIG. 1, a sensor and transmitter system 9 may comprise a fingerprint scanner 10 (optical, capacitive, etc.), a processor 12 having a memory 14 associated therewith (preferably of the non-volatile type), a remote function actuation transmitter, and may also include battery 23 and/or solar cell 25. Also, sensor and transmitter system 9 may additionally comprise receiver 29 as will be discussed more fully hereinbelow. While only one sensor and transmitter system 9 is shown in FIG. 1, it will be clear that two or more such systems may be employed. Furthermore, in an alternate embodiment, scanner and transmitter system may 9 be implemented as a portable unit. Biometric data is processed to determine if a potential user is authorized. This processing may take place within scanner and transmitter system 9 and/or exterior to system 9, or remotely if desired.

An optical fingerprint sensor is based upon the illumination of the finger surface using, for example, visible light, infrared light, or ultrasonic radiation. The heart of an optical fingerprint scanner system is typically a charge coupled device (CCD) or CMOS imagine sensor of the type which comprises an array of light-sensitive diodes or photosites that generate an electrical signal in response to light photons. Each photosite records a pixel; a tiny dot representing a light that hits that spot. Collectively, the light and dark pixels form an image of the scanned fingerprint. An analog-to-digital converter in the scanner system processes the analog electrical signals to generate a digital representation of the fingerprint image. The scanning process commences when an individual's finger (i.e. that of a person desiring access to vehicle 18) is placed on a glass plate (e.g. 20 in FIG. 1), and a CCD camera takes a picture. The scanner has its own light source (e.g. an array of light emitting diodes) to illuminate the ridges of the fingerprint. The CCD system actually generates an inverted image of the finger, with darker areas representing more reflected light (the ridges of the fingerprint) and lighter areas representing less reflective light (the valleys between the ridges). The scanner processor (e.g. 12 in FIG. 1) assures that the CCD has captured a clear image. It checks the average pixel darkness (or the overall values in a small sample) and rejects the scan if the overall image is too dark or too light. If the image is rejected, the scanner adjusts the exposure time to let in more or less light and then tries again.

If the darkness level is adequate, the scanner system goes on to check the image definition; i.e. how sharp the fingerprint scan is. The processor observes several straight lines moving horizontally and vertically across the image. If the fingerprint image has good definition, a line running perpendicular to the ridges will be made up of alternating sections of very dark pixels and very light pixels. If the processor finds that the image is crisp and properly exposed, it proceeds to compare the captured fingerprint with the parameters of fingerprints on file and stored in, for example, memory 14.

An example of an optical scanner is shown and described in U.S. Pat. No. 4,525,859 issued Jun. 25, 1985 and entitled “PATTERN RECOGNITION SYSTEM”. Such systems, however, suffer certain shortcomings. For example, optical scanning schemes may require relatively large spacings between the finger contact surface and associated imaging components. Moreover, such sensors typically require precise alignment and complex scanning of optical beams. Accordingly, optical sensors may thus be bulky and susceptible to shock, vibration, and surface contamination.

Capacitive scanners, like optical scanners, generate an image of the ridges and valleys that make up a fingerprint but instead of sensing the fingerprint using light, capacitors utilize electric current. FIG. 3 is a schematic diagram of a simple capacitive sensor. The sensor comprises one or more integrated circuits containing an array of tiny cells 22, each cell including two conductive plates 24 covered by an insulating layer 26 (e.g. glass). A finger 28 having a finger ridge 30 and a finger valley 32 is shown resting on plate 26. Each of cells 22 is smaller than the width of one ridge 30 on finger 28.

Each of cells 22 includes an integrator comprising an inverting operational amplifier 34 having an inverting input 36 coupled to a first terminal of an input capacitor 38, a non-inverting input 40 coupled to a source of supply voltage (e.g. ground), an output terminal 42, and first and second supply voltage terminals 44 and 46 respectively. A reset switch 48 is coupled between plates 24. As is well known inverting amplifier 34 alters a supply voltage based on the relative voltage at the inverting and non-inverting inputs 36 and 40 respectively. Inverting input 36 is coupled to a first one of plates 24, and the amplified output 42 is coupled to a second one of plates 24.

Plates 24 form two plates of a capacitor capable of storing charge. The surface of finger 28 acts as a separate capacitor plate separated by insulating layer 26 and, in the case of the fingerprint valleys 32, by a pocket of air. Varying the distance between the plates (by moving finger 28 closer or farther away from plates 24) changes the total capacitance (i.e. the ability to store charge) of the capacitor. Because of this, the capacitor in a cell under a ridge 30 will have a greater capacitance than it would if it were under a valley.

To scan a finger, the processor first closes reset switch 48 for each cell. This shorts inverting input 36 and output 42 to balance the integrator circuit. When switch 48 is opened again, the processor applies the fixed charge to the integrator circuit, and the capacitors charge up. The capacitance of the feedback loop impacts the voltage at the amplifier's input which, in turn, affects the amplifier's output. Since the distance to the finger alters capacitance, a finger ridge will result in a different voltage output than a finger valley. The scanner processor reads the output voltage and determines whether it is characteristic of a ridge or a valley. By reading every cell in the sensor array, the processor can construct an overall picture of the fingerprint similar to the image captured by an optical scanner. One example of a fingerprint sensor which utilizes an array of extremely small capacitors located in a plane parallel to the sensing surface of the device is shown and described in U.S. Pat. No. 4,353,056 issued Oct. 5, 1982 and entitled “CAPACITIVE FINGERPRINT SENSOR”.

It is well known that using an entire fingerprint image in a comparative analysis requires a great deal of processing power. Therefore, most fingerprint scanner systems compare specific features of a fingerprint, generally known as minutiai. Typically, comparators concentrate on points where ridge lines end or where one ridge splits into two.

Fingerprint scanning systems utilize well known algorithms to recognize and analyze the minutiai. The basic idea is to measure the relative positions of minutiai in the same sort of way one might recognize a region of the sky by the relative positions of the stars. If one were to consider the various shapes that would result if straight lines were drawn between various minutiai, then if two fingerprints have a predetermined number of ridge endings and/or bifurcations forming the same shape with the same dimensions, there is a high likelihood that they are from the same print. In this manner, a fingerprint scanner system does not have to compare the entire fingerprint with others on record, but simply has to find a sufficient number of minutiai patterns that two prints have in common.

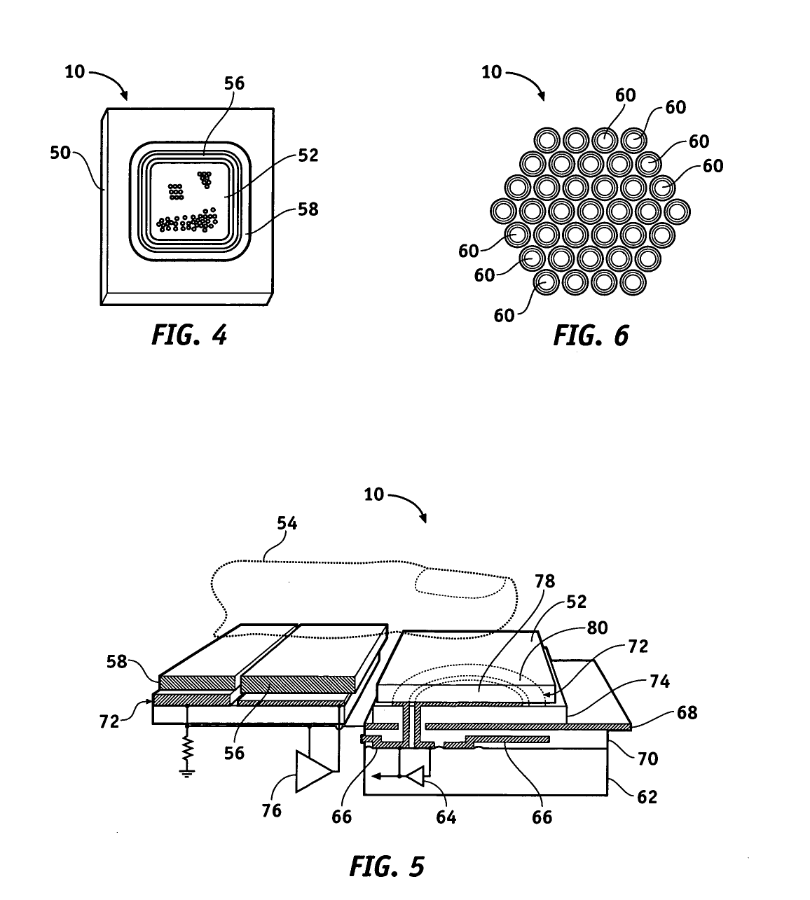

FIGS. 4, 5, and 6 illustrate an example of a fingerprint sensor 10 suitable for use in the biometric keyless entry system shown in FIG. 1. Sensor 10 includes a housing 50 having a dielectric layer 52 exposed on an upper surface thereof to provide a placement surface for finger 54. A first conductive strip or external electrode 56 around the periphery of dielectric layer 52 and a second external electrode 58 serve as contact electrodes for finger 54. The sensor includes a plurality of individual pixels or sensing elements 60 arranged in an array or a pattern as shown in FIG. 6. As stated previously, these sensing elements are relatively small so as to be capable of sensing ridges 30 and intervening valleys 32 of a typical fingerprint. Sensor 10 includes a substrate 62 having one or more active semiconductor devices formed thereon (e.g. amplifier 64). A first metal 66 interconnects the active semiconductor devices. A second or ground plane layer 68 resides above first metal layer 66 and is separated therefrom by an insulating layer 70. A third metal layer 72 is positioned above another dielectric layer 74. External electrode 56 is coupled to an excitation drive amplifier 76 which, in turn, drives finger 54 with a signal typically in the range of 1 KHZ to 1 MHZ.

A circularly shaped electrical field sensing electrode 78 resides on insulating layer 74. Sensing electrode 78 may be coupled to sensing integrated electronics such as amplifier 64. An angularly shaped shield electrode 80 is spaced from and surrounds sensing electrode 78.

The overall contactor sensing surface of sensor 10 may be approximately 0.5 by 0.5 inches which is sufficiently large enough for accurate fingerprint sensing and identification. This small size permits its incorporation into a portable device such as a keyfob transmitter. Sensor 10 may include an array of 256×256 pixels and may be fabricated using conventional manufacturing techniques. For more detailed discussion, the interested reader is directed to U.S. Pat. No. 5,903,225 issued May 11, 1999 and entitled “ACCESS CONTROL SYSTEM INCLUDING FINGERPRINT SENSOR ENROLLMENT AND ASSOCIATED METHODS”.

Referring again to FIG. 1, processor 12 is coupled to a remote function activation transmitter 13 which is capable of transmitting an activation signal to a wireless receiver 15. Wireless receiver 15 is coupled to control and distribution unit 17 which provides an output along one of lines 19 to door lock 21. Control and distribution unit 17 may also provide outputs for controlling lights, activating or deactivating security functions, enabling the ignition, starting the heater, and the like. Processor 12 and memory 14 may be of the conventional type and comprise well known microprocessor/memory configurations. The system shown in FIG. 1 is preferably battery operated as is shown at 23. A solar cell 25 may also be provided for recharging purposes.

The biometric keyless entry system shown in FIG. 1 operates as follows. A person desiring access to vehicle 18 places a finger on window 20 of fingerprint scanner 10. The finger is scanned and the resulting data sent to processor 12 where it is compared with one or more binary templates representing stored biometric samples which were stored during a previous enrollment phase. That is, parameters relating to fingerprints of individuals authorized to have access to vehicle 18 are previously stored in memory 14. Real time fingerprint capture via fingerprint scanner 10 is authenticated against a user's fingerprint template stored in memory 14, and access to the vehicle is either granted or denied depending on the result of this authentication process. If authenticated, processor 14 is informed of the authentication, and remote function activation transmitter 13 sends a wireless authentication signal to wireless receiver 15. Receiver 15 informs control and distribution unit 17 that an authentication has been successfully performed and, in response thereto, control and distribution unit 17 sends a door unlock activation signal to door lock 21 via one of lines 19.

As above described, sensor and transmitter system 9 may perform the authentication process. If desired, however, system 9 may be utilized to send the biometric image itself, or certain key characteristics of the image, to receiver 15 which, with the assistance of processor/memory 11 completes the authentication process. Further, if desired, the authentication process could take place at a remote site through the utilization of a longer range wireless system, e.g., the cellular phone system.

Enrollment of a new user may be accomplished internally using sensor and transmitter system 9 or external to system 9 by means of an additional transmitter 27 and an additional receiver 29 coupled to processor 12. Thus, enrollment may be handled within the vehicle itself or remotely (e.g. utilizing a home personal computer) and then stored in system 9. Transmitter 27 may be associated with receiver 15 as shown in FIG. 1 or may be completely separate; e.g. a cellular telephone. In like fashion, the Remote Function Actuation Transmitter 13 and Receiver 15 could also be a wireless link other than the Remote Function Actuation system, e.g., the cellular phone network. All of system 9 could be incorporated into a cellular phone.

Thus, there has been provided a keyless entry system utilizing biometric identification (e.g. fingerprints) which, due to its wireless nature, permits system deployment without extensive vehicle integration. The invention has been described in connection with fingerprint matching; however, other biometric parameters may be used such as iris and retinal scans, speech, facial thermograms, and hand geometry. The inventive keyless entry system grants access to the vehicle based on who an individual requesting access is as opposed to what that individual knows or possesses; that is, based on the individual physiological characteristics.

What is claimed is:

1. A keyless entry system for use on a vehicle, the system comprising:
a first processor on-board the vehicle for receiving biometric data and comparing said biometric data with stored data; and
a biometric scanner coupled to said first processor and accessible from the exterior of the vehicle for deriving said biometric data.

2. A system according to claim 1 wherein said biometric scanner comprises a fingerprint scanner.

3. A system according to claim 2 further comprising a transmitter coupled to said first processor for generating an activation signal when said biometric data substantially matches said stored data.

4. A system according to claim 3 wherein said transmitter is a wireless transmitter.

5. A system according to claim 4 further comprising a first wireless receiver system for generating a control signal upon receipt of said activation signal.

6. A system according to claim 5 wherein the vehicle includes a door lock coupled to said first wireless receiver and wherein said control signal is a door unlock signal.

7. A system according to claim 1 wherein said biometric scanner is mounted on an exterior surface of a door of said vehicle.

8. A system according to claim 7 wherein the door of said vehicle is provided with a door handle and wherein said biometric scanner is positioned proximate the door handle.

9. A system according to claim 2 further comprising a second wireless receiver coupled to said processor.

10. A system according to claim 6 wherein said fingerprint scanner is an optical scanner.

11. A system according to claim 6 wherein said fingerprint scanner is a capacitive scanner.

12. A system according to claim 6 wherein said system is powered by a battery.

13. A system according to claim 12 wherein said battery is solar charged.

14. A system according to claim 5 further comprising a memory coupled to said first processor for storing said stored data.

15. A system according to claim 14 wherein said stored data is in the form of fingerprint templates.

16. A system according to claim 2 further comprising:
a first wireless receiver;
a wireless transmitter coupled to said first processor for transmitting a representation of at least a portion of said biometric data to said first wireless receiver; and
a second processor coupled to said first wireless receiver for authenticating said representation.

17. A system according to claim 16 wherein said first wireless receiver generates a control signal when said representation is authenticated.

18. A keyless entry system for unlocking a door-lock of a vehicle's door, comprising:
a processor on-board the vehicle for receiving fingerprint data and comparing said fingerprint data with stored fingerprint data;
a fingerprint scanner coupled to said processor and accessible from the exterior of said vehicle for generating said fingerprint data;
a transmitter coupled to said processor for transmitting a wireless activation signal when said fingerprint data substantially matches the stored fingerprint data; and
a wireless receiver system coupled to the door lock for unlocking the door in response to receipt of said activation signal.

19. A system according to claim 18 wherein said biometric scanner is mounted on an exterior surface of a door of said vehicle.

20. A system according to claim 19 wherein the door of said vehicle is provided with a door handle and wherein said biometric scanner is positioned proximate the door handle.
